(19) United States
(12) Patent Application Publication
(10) Pub. No.: US 2017/0182555 A1
(43) Pub. Date: Jun. 29, 2017

(54) LAYER-BY-LAYER PRODUCTION METHOD DURING LASER MELTING (SLS) IN GRAVITY DIE CASTING OPERATIONS

(71) Applicant: KS Kolbenschmidt GmbH, Neckarsulm (DE)

(72) Inventors: Udo BUSCHKAMP, Hansen o. V. (DE); Stanislav Stanchev, Heilbronn (DE)

(21) Appl. No.: 15/313,143

(22) PCT Filed: May 27, 2015
(86) PCT No.: PCT/EP2015/061695

§ 371 Date: Nov. 22, 2016

(30) Foreign Application Priority Data
May 27, 2014 (DE) 10 2014 210 074.7

(51) Int. Cl. B22F 3/105; B29C 67/00

(52) U.S. Cl. CPC B22F 3/1055; B29C 67/0077; B22F 3/105; B22F 5/007

(57) ABSTRACT

The invention relates to the use of direct metal laser sintering (DMLS) for the production of a casting mold, in particular a permanent mold, in order to avoid air pockets in internal combustion engine pistons manufactured in a gravity die casting process, wherein at least one portion of the casting mold has a plurality of small openings, in particular microscopic holes, for discharging air. The invention also relates to a method for producing a casting mold, in particular a permanent mold, for gravity die casting pistons for internal combustion engines.

### TECHNICAL FIELD

The invention relates to laser-sintered casting molds for gravity die casting, in particular for the manufacture of pistons for internal combustion engines.

### BACKGROUND

During die casting, molten metals are cast in permanent molds in a rising or falling manner under the influence of gravity or low pressures.

DE 102014211350 A1 relates to a piston of metal or a metal alloy for an internal combustion engine, the piston, or at least a part of the piston, being manufactured in a casting process on the basis of a lost mold or in a casting process on the basis of a permanent mold, and relates to a method for its manufacture. The gravity die casting method is disclosed here as a method for manufacturing a piston on the basis of a permanent mold.

In gravity die casting, the molten metal is poured into the casting mold (die) under the influence of gravity by way of a pouring system. The shrinkage porosity occurring is offset by so-called feeders and the solidification of the material is controlled by cooling the casting mold. On account of the low porosity, very good mechanical properties can be achieved by way of a heat treatment.

Main application areas are light metal die casting (aluminum die casting alloys and magnesium alloys) for the manufacture of pistons for internal combustion engines.

In the case of simple casting molds, the filling may be performed manually, for which a casting mold (die) has dedicated mechanical moving elements. In the case of relatively large piston production runs, die casting machines or mechanized or automated die casting installations are used. The individual operations, such as placing in the core, closing the mold, casting, cooling, opening the mold, ejecting and removing the cast part, blowing out and coating, can in this case be performed in an automated manner.

Die casting differs from sand casting especially in that the metal molding material with its high thermal conductivity—in comparison with molding sand—brings about accelerated cooling of the solidifying melt. As a consequence of this relatively rapid solidification, a relatively fine-grained and dense microstructure is produced. This is accompanied by better mechanical properties and a high leak-tightness of the pistons. The greater reproducibility along with the achievement of a dense microstructure have the effect that pistons are manufactured with preference by the die casting method and not by sand casting.

Further advantages of die casting over sand casting are better dimensional accuracy and great dimensional stability, better surface quality and exact contour reproduction by the metal permanent mold, elimination of the need for sand preparation, a high output in the case of simple parts, a shorter manufacturing time and cycle time on account of the rapid solidification and the possibility of installing an automated procedure.

A distinction is drawn between dies (casting molds) with a vertical main parting plane and a horizontal main parting plane and, according to type, also between full dies, hybrid dies (with sand cores) and half-dies (each with a sand-casting half and a die-casting half).

Vertically divided dies can be operated manually and for casting are placed on a table. Both die halves are provided with guiding dowels or guiding pins for exact opening and closing. Larger dies are moved on an additional guiding rail, which is embedded in the casting table.

Dies with a horizontal main parting plane consist of a horizontally lying baseplate, on which there slide two or more core slides, which enclose a metal core to be taken out vertically upward. Additional cores may be additionally inserted into the slides and into the baseplate. When there are high numbers of pistons, and to shorten the cycle time, rotary casting machines are also used.

Structural steels, cast iron with flake graphite, hot-working steels, special molybdenum alloys or tungsten heavy metals may be used for example as die materials for particularly heavy-duty mold components.

The light metal casting materials that can be used for die casting, for example aluminum die casting alloys, are standardized. In the same way as for sand castings, die-cast parts are also unrestrictedly able to undergo heat treatment and are suitable for welding.

Before casting, the casting mold (die) must be satisfactorily coated and preheated, for which gas burners are generally used. The coating withstands a number of casting cycles, and therefore only has to be repaired or renewed when required. A sufficiently warmed die normally needs no further heating during the casting operation. The heat exchange that takes place in each casting operation is enough to maintain the mold temperature appropriate for casting. In the case of more complex cast parts, however, additional heating or else mold cooling may well be required.

In the case of the standard die casting method, the mold filling takes place with the aid of gravity and generally in the rising casting, that is to say that the molten metal is introduced through a sprue and then flows over a runner, which is arranged underneath and possibly to the side of the actual cast part, via the gate(s) into the mold cavity. In this way, the mold is filled rising from the bottom to the top. The following factors have an influence on the mold filling time: the inflow rate of the alloy, the gate cross section, the geometry and the thermal conductivity of the alloy and of the die.

After the casting, the following operations for example may be carried out: stamping, sawing, deburring, radiographic examination, heat treatment, slide grinding, sand blasting, machining, coating, cleaning/washing and/or fitting.

In the gravity die casting application, the molten metal is poured into the metal permanent mold (die) under the effect of gravity.

The advantages of the method are for example outstanding material properties, creation of complex internal geometries (with the aid of sand cores), low tool costs in comparison with die casting, a high degree of automation and also leak-tightness. Commercial order volumes for die casting are small to large piston production runs.

Die casting is particularly suitable for pistons because of their workpiece geometries and their high material requirements. Undercuts can be created by using sand cores.

The production of casting molds (dies) for the casting of pistons is very complex on account of the shaping of pistons. It must also be ensured that there are no air pockets in the cast piston.

### SUMMARY

The object of the invention is therefore to provide a method for producing casting molds for gravity die casting that makes uniform venting of the mold possible.

According to the invention, the use of direct metal laser sintering (DMLS) for the production of a casting mold, in particular a die, is provided to prevent air pockets in pistons for internal combustion engines that are manufactured by gravity die casting, at least one region of the casting mold having a number of small openings, in particular microscopic holes, for discharging air. It has surprisingly been found that, as a result of the layer-by-layer buildup of the casting mold, finer gas and water-permeable structures can be produced in casting molds for gravity die casting by direct laser metal sintering (DMLS) than for example by electrical discharge machining. In the manufacture of pistons for internal combustion engines, it has proven to be advantageous to create microscopic holes in order to discharge the air that is in the casting mold. Furthermore, costs and time are saved by the direct production of the casting mold.

### BRIEF DESCRIPTION OF THE DRAWINGS

Exemplary embodiments of the invention are shown in the figures and described below.

FIG. 1: shows a sectional view of an upper piston part;

FIG. 2: shows a sectional view of a further upper piston part;

FIG. 3: shows a sectional view of a further upper piston part deviating from FIG. 1 and FIG. 2;

FIGS. 4A and 4B: show two sectional views of an upper piston part deviating from FIGS. 1 to 3; and

FIG. 5 schematically shows a test piece.

### DETAILED DESCRIPTION

According to the invention, a method for producing a casting mold, in particular a die, for gravity die casting for the manufacture of pistons for internal combustion engines is provided, the casting mold being produced by direct metal laser sintering (DMLS). In the case of direct laser metal sintering, the casting mold is produced directly from CAD or 3D data. Complex construction of the casting mold by machining methods for example is no longer required. The development time for a piston manufactured by gravity die casting is significantly reduced. A casting mold may for example be designed and produced directly on site at the premises of the piston manufacturer.

It is also provided according to the invention that the casting mold is produced layer by layer by a laser acting on metal powder. The metal powder is used without any additives, such as for example binders. The layer-by-layer buildup allows the casting mold to take on any geometrical form.

It is also provided according to the invention that the casting mold has a sintering base. A sintering base is the term used for a region in the casting mold that has extremely small openings.

It is also provided according to the invention that the sintering base has microscopic holes. These microscopic holes allow the air to be reliably removed from the casting mold for a piston during the casting operation. The quality of the cast piston increases because its microstructure is free from air pockets.

It is also provided according to the invention that the microscopic holes are produced with a diameter of less than 0.50 mm, preferably of less than 0.3 mm, in particular between 0.1 and 0.25 mm. It has been found that, in particular in the case of microscopic holes with a diameter of between 0.15 and 0.25 mm, water reliably passes through and leaves the microscopic hole as a jet.

It is also provided according to the invention that the microscopic holes with a diameter has the aforementioned diameters over a depth of between 1 and 10 mm, in particular at a depth of between 4 and 6 mm. A depth of between 1 and 10 mm, in particular a depth of between 4 and 6 mm, of the microscopic hole with a diameter of less than 0.50 mm, preferably of less than 0.3 mm, in particular between 0.1 and 0.25 mm, has proven to be advantageous, since it ensures the stability of the casting mold in the region of the sintering base and makes reliable discharging of the air from the casting mold possible in the casting process.

It is also provided according to the invention that the casting mold produced by direct metal laser sintering (DMLS) is subjected to a heat treatment to increase the strength and toughness properties of the casting mold. The subsequent heat treatment has the effect that the service life of the casting mold is improved. The casting mold withstands better the loads in the casting process.

It is also provided according to the invention that the casting mold has temperature-control channels adapted to the topography of its form. The temperature-control channels may precisely follow the shape of the piston form that is replicated in the casting mold. As a result, better heat exchange is made possible. Before the casting, the casting mold can be preheated by way of the temperature-control channels. During the casting process, the casting mold can be cooled when required by way of the temperature-control channels.

It is also provided according to the invention that, to avoid flow disturbances, the temperature-control channels have fine filters at their temperature-control entry points. Fine filters at the temperature-control entry points of the temperature-control channels prevent the temperature-control channels from being blocked by contaminants in the heat exchange medium. A reliable heat exchange over the entire service life of the casting mold is thereby ensured. The fine filters may likewise be produced by direct laser metal sintering. They may be made in one piece with the casting mold or be produced as a separate component.

It is also provided according to the invention that the casting mold is made in a hybrid type of construction with a base. The hybrid type of construction has the advantage that the base, which is made to match the respective die casting machine, can always be made the same.

It is also provided according to the invention that the base serves as a basis for the buildup of a piston-specific casting mold by direct metal laser sintering. The base consequently serves as a basis for the direct laser metal sintering process and may preferably be made as a nonvariable part. The base can consequently be produced in large numbers, which lowers the costs for the casting mold.

It is also provided according to the invention that the functional elements for the casting operation, such as for example cooling, ejector and threaded holes, are introduced into the base region before the laser melting operation. By introducing the functional elements into the base, the transfer to the die casting machine is ensured. The interface for the media transfer is placed close to the actual casting mold for the piston for an internal combustion engine.

Direct metal laser sintering (DMLS) is a generative rapid prototyping process which, according to the invention, is used for the direct production of tools, known as rapid tools, for gravity die casting for the manufacture of pistons for internal combustion engines.

Direct metal laser sintering (DMLS) is also referred to as “selective metal laser melting”, “selective metal laser sintering”, or just “metal laser sintering” and is also referred to as a selective laser melting method (SLM) or selective laser melting (SLM) for short. DMLS is an additive manufacturing process in which casting molds for gravity die casting for the manufacture of pistons for internal combustion engines are produced directly from the 3D design data or CAD data by layer-by-layer melting of metal powder with the aid of laser beams. No binders or other additives are required for the processing of metal materials with the aid of DMLS or SLM. For particularly precise casting mold structures, micro-laser sintering (MLS) may also be used.

The generated components have a homogeneous microstructure and relative densities of almost 100%. However, not only the physical properties but also the mechanical properties of the components produced correspond to those of cast structures.

By contrast with conventional production methods, the method offers very great freedoms of design in the component geometry. As a result of the layer-by-layer buildup of casting molds, the DMLS or SLM method makes the production of any desired cavities and undercuts possible. Moreover, a number of functions can be integrated in the casting mold. Only the demoldability of the piston from the casting mold sets limits on the geometrical design of the casting mold. Thanks to this enormous freedom of design, there is the possibility not only of individualizing pistons but also of increasing the number of their variants almost at will.

The use of DMLS or SLM for the production of casting molds (dies) for gravity die casting of pistons has the effect of shortening the overall process chain, and consequently the manufacturing time of the individual piston. For small piston production runs and internal combustion engines with very short product life cycles, this saving of time represents a great competitive advantage. Specifically in areas with small casting molds of minimal batch sizes and complex geometries, the DMLS or SLM method is an advantageous alternative to conventional casting mold production.

In the case of the DMLS or SLM method, the complexity of the casting mold has only a minor influence on the unit costs, since they are especially volume-dependent and not geometry-dependent. Particularly well-suited for the DMLS or SLM method are casting molds of high complexity, since it is either very cost-intensive or not possible at all for them to be produced by the conventional methods. Consequently, pistons with complex geometries that previously could not be manufactured at all, or only with very great expenditure, can be manufactured by the gravity die casting method.

In the case of selective laser melting, metal powder is first applied in a thin layer to a baseplate. A laser then selectively makes the powder melt with a strong laser beam. Serving it as a basis are digital 3D design data of the casting mold for the gravity die casting of the die. After that, the baseplate is lowered by a layer thickness and a new layer of powder is applied. The metal powder is once again melted precisely with the laser and bonded to the layer lying thereunder. This cycle is repeated until all of the layers have been melted through. The finished casting mold is subsequently removed from the baseplate, cleaned, machined if required or can be used immediately.

DMLS or SLM offer the following important advantages in the production of dies. DMLS or SLM is a highly flexible, cost-attractive production method, there is virtually complete geometrical freedom, it makes rapid manufacture of complex components possible, it makes a great saving of time possible and heavy-duty components that require little material are produced.

It has been found that, by subsequent sintering, the porosity of laser-sintered structures can be eliminated completely. Furthermore, a heat treatment improves the strength and toughness properties of the laser-sintered die. The laser-sintered densities lie in the range of 95-97% of the theoretical density. A subsequent sintering treatment has the effect that the microstructure of the casting mold is homogenized and the residual pore content is virtually eliminated or even eliminated completely.

The use of customary powders used in powder metallurgy for the material system allows rapid, uncomplicated and inexpensive production of the steel alloy. The laser-sintered structures are particularly suitable for use as a casting mold or die in the gravity die casting method.

With cooling that closely follows the piston contour, a shortening of the cooling time by up to 50% is achieved, and as a result a shortening of the casting cycle by up to approximately 30%.

This results in a massive potential for improvement with regard to costs, improved surface quality, greater dimensional stability and much less distortion. These are particularly advantageous possibilities for saving and improvement.

With DMLS, mold inserts, core slides and mold cores can be produced with extremely effective cooling/temperature control close to the contour for the gravity die casting of pistons.

The dimensionings, passage contours and arrangements of the temperature-control holes are made to match the respective topography of the form of the casting mold (the die) and of the piston produced from it.

A rapid and nevertheless uniform removal of heat is achieved by the cooling channels that are then sufficiently dimensioned and optimally arranged in the region of the cavity near the surface, which leads to significant shortenings of the casting cycle and improvements in quality.

Mold components for the casting mold can be produced in a hybrid type of construction, the massive base regions consisting of machined semifinished products. The actual casting mold (the die) can then be built up on them. This type of construction considerably reduces the expenditure in terms of time and costs.

The provision of the base and the subsequent surface machining operations can be performed in the making of the mold.

In the case of the hybrid type of construction, the cooling, ejector and threaded holes, etc. are introduced into the base region before the laser melting operation.

Optionally, the temperature-control channels may be provided with a special corrosion protection.

In order to avoid flow disturbances that are possible with the sometimes very narrow hole cross sections, corresponding fine filters may be placed in front of the temperature-control entry points.

In the production of casting molds, savings of up to 80% are achieved by laser melting in comparison with conventional methods, with at the same time a significant reduction in the production time.

Fully load-bearing, metal casting molds can be produced from 3D data.

DMLS enables designers for the first time to make casting molds for technically extremely demanding pistons, entirely free from restrictions imposed by machining techniques.

The following properties can be realized on a casting mold for gravity die casting: a void-free wall structure, a stable design, a curable material, a double-walled design or else a design with a lattice structure, a drilled wall, multiple undercuts, irregularly running holes, structured cavities, with a concave or convex inscription and/or similar structures.

Subsequent machining operations by milling, turning, grinding, hardening, coating for threads, bearing seats, joining surfaces, etc. can be carried out as post-machining on the casting molds after they have been produced by DMLS.

DMLS is suitable for the production of casting molds from metal for piston prototypes and one-off pistons and for pistons of relatively small and medium production runs. This very rapid and precise layer buildup method can be used with virtually all metals and certain ceramic materials. This technology supports the strong trend toward smaller batch sizes in the production of pistons and the individualization of pistons. Consequently, laser sintering offers great advantages in the production of casting molds for gravity die casting in comparison with conventional mold-bound methods that require a minimum size of the production run to make up for the high mold costs.

Casting molds for gravity die casting for the manufacture of pistons for internal combustion engines can be produced without the use of special tools. That shortens the development time significantly and saves manufacturing costs. A further advantage is the great dimensional and shape stability of the casting molds produced by DMLS.

Complex geometries are three-dimensional structures that often have undercuts or cavities. Many complex geometries can only be produced to a limited extent or at high costs by conventional technologies such as milling, turning or casting. In the case of conventional production methods such as milling, turning or casting, the production costs are strongly linked to the complexity of the casting mold or the piston produced from it, since fabrication of complicated molds or complex special solutions is usually necessary.

Every conceivable form of casting mold that can be designed with a 3D-CAD program can also be produced by laser sintering technology. There is no restriction, not even in the production of hollow structures. This is possible because material is only applied at the locations at which this is envisaged in the 3D model.

The complexity of a casting mold no longer has to be dictated by the production method, but by the desired function and the design of the piston produced from the casting mold. The more complex the geometry of a casting mold is, the more additive manufacturing is worthwhile.

Additive manufacturing technology on the basis of DMLS makes it possible to carry out changes to the casting molds at short notice.

With additive manufacturing on the basis of DMLS, the manufacturer is taken directly from the first design concept to the finished casting mold.

A great advantage of additive manufacturing is that of proceeding very easily from the design to the construction of the casting mold. The production of the casting mold takes place directly on the basis of the digital 3D data. As a result, tests closely resembling the production run can be carried out quickly and prototypes can be optimized on the basis of the results. This iterative process is not envisaged in the case of linear product development models. And yet, it is also the case in the traditional product development process that aberrant developments and complications cause iteration loops, which lead to increased development costs.

In the case of additive manufacturing, all casting molds are produced on the basis of virtual models. On the one hand, this allows an easy possible way of conducting virtual load tests. On the other hand, the direct production makes it possible to carry out rapid production of casting molds for example for the manufacture of piston prototypes with material properties identical to those of the finished piston. The advantage of this design process is the possibility of checking the function of the casting mold or of the piston produced from it at any time in virtual or actual reality. Changes can be easily realized in the piston development phase, and with only low extra costs in comparison with conventionally produced pistons.

Additive manufacturing on the basis of DMLS makes economical production possible in the case of one-off pistons and also in the case of mass piston production. The complexity of a casting mold or of a piston produced from it scarcely plays any role for the production time and costs.

DMLS makes it possible for temperature-control channels to be integrated in casting molds and casting mold inserts directly and close to the contour. The optimized dissipation of heat makes shorter cycle times possible and also greater productivity and workpiece quality in gravity die casting mass production.

In conventional casting mold construction, temperature-control or cooling channels can only be drilled in straight lines. Therefore, critical hotspots often cannot be reached by coolants, and consequently also cannot be nullified.

With DMLS, on the other hand, it is possible to integrate optimized cooling channels in the casting mold directly and close to the contour during production. As a result, heat is dissipated much more quickly and uniformly. This reduces the thermal stresses in the casting mold and ensures longer mold service lives. Furthermore, the quality and dimensional stability of the pistons produced increase. In addition, the cycle times can be shortened drastically.

The additive manufacturing of DMLS does not require any tooling. It makes production of casting molds that is individualized and adapted to the batch size possible.

As a difference from conventional production methods, additive manufacturing on the basis of DMLS manages without tools or molds. This technology is therefore independent of the number of units. Casting molds, and consequently the pistons produced from them, can be digitally individualized and produced cost-effectively in small numbers or even as one-offs.

Additive manufacturing on the basis of DMLS makes possible the design and production of high-strength lightweight structures where conventional production methods fail.

Casting molds should only use resources to the extent that is absolutely necessary for performing their functions. Since raw material consumption, and consequently also prices for resources, are globally increasing enormously, this requirement is coming ever sharper into focus in piston development and manufacture.

Additive manufacturing technology on the basis of DMLS can build up lightweight structures to any degree of fineness and complexity. As a result, it gives developers maximum freedom of geometrical design. Even in the design process, superfluous material that is unavoidable in conventional production can be removed from many regions of the casting molds. In production, material is then only applied where it is functionally necessary. Thus, extremely lightweight and nevertheless high-strength casting molds are produced. As a result, freedom in design and esthetics is gained.

Additive manufacturing is the term used for a process in which a casting mold is built up by depositing material layer by layer on the basis of digital 3D design data. The term “3D printing” is being used increasingly frequently as a synonym for additive manufacturing. However, additive manufacturing describes better that this is a professional production process that differs significantly from conventional, material-removing production methods. Instead of for example milling a casting mold out of a solid block, additive manufacturing builds up the casting mold layer by layer from materials that are in the form of a fine powder. Various metals and composites are available as materials.

Additive manufacturing on the basis of DMLS shows its strengths where conventional production encounters limits. DMLS technology takes up where design and production have to be newly thought through to find solutions. It makes possible a “design-driven manufacturing process”, in which the design determines the production, and not vice versa. In addition, additive manufacturing allows extremely complex casting mold structures, which at the same time can be extremely light and stable. It allows a high degree of freedom of design, functional optimization and integration, the production of small batch sizes at reasonable unit costs and great individualization of pistons, even in mass production.

With the aid of DMLS, sintering bases are produced for use in the casting mold for the manufacture of pistons. These casting molds have microscopic holes for discharging air during the process of casting pistons for internal combustion engines.

In other words, the use of DMLS makes it technically possible to produce in the casting mold (die) cavities for flooding with cooling media or discharging the air during mold filling. With respect to discharging the air, the diameter of the holes of 0.2 mm should not be exceeded, in order that the openings in the metal do not become clogged. With DMLS, no technical limits are imposed on the form and size of the cavities (producibility).

For the air discharges of the casting molds (bottom molds), previously round sintered metal blanks have been used as the starting material and the contours worked with the aid of electrical discharge machining.

Electrical discharge machining is the removal of material by an electric current. Electrical discharge machining methods (spark erosion for short) are used for the high-precision machining of materials. The electrically conducting sintered metal blank to be machined is machined in a non-conducting liquid (dielectric, usually deionized water or else oil). For this purpose, a likewise electrically conducting tool, which has a negative electrical voltage (typically 40 . . . 150 V) with respect to the sintered metal blank, is brought into the vicinity of the sintered metal blank. This generates numerous small discharges between the tool and the sintered metal blank. This leads to constantly recurring sparks, which primarily remove material from the sintered metal blank. However, the tool is also eroded, and must therefore be renewed.

Electrical discharge machining (EDM for short) is a thermal, material-removing production method for conductive materials that is based on electrical discharge processes (sparks) between an electrode (tool) and a conducting workpiece, for example the sintered metal blank. The machining takes place in a non-conducting medium, known as the dielectric. The electrode tool is in this case brought up to the sintered metal blank to within a narrow gap (<0.5 mm), until a spark jumps across, causing the material to melt and vaporize at this point. Depending on the intensity, frequency, duration, length and polarity of the discharges, the various removal results are obtained.

A distinction is drawn between spark-erosive drilling (hole-drilling EDM), spark-erosive cutting (wire-cut EDM), in which a wire forms the electrode, and spark-erosive sinking (die-sink EDM), in which the electrode as a negative form is pressed into the workpiece with the aid of an EDM machine. Even complicated geometrical forms can be produced. However, the EDM method is very time-consuming and therefore cost-intensive.

On account of being producible in the casting mold (bottom, sleeve, die, core), the cooling channels could only be brought approximately into the desired cooling position, and is also adversely influenced by the cross sections and profiles of the cooling geometries that cannot otherwise be produced.

In order to remove the air from the casting mold during the casting operation, it has also been necessary for an extractor to be attached. That often had the consequence that various negative pressures prevailed in the casting mold (due to infiltrated air being drawn in), and consequently there has also been variance in the casting quality. The high level of noise is harmful to employees. Inhomogeneity of the material of the sintered blanks has meant that the mold service lives are short and/or vary greatly (3-15,000 cycles).

[symbol]

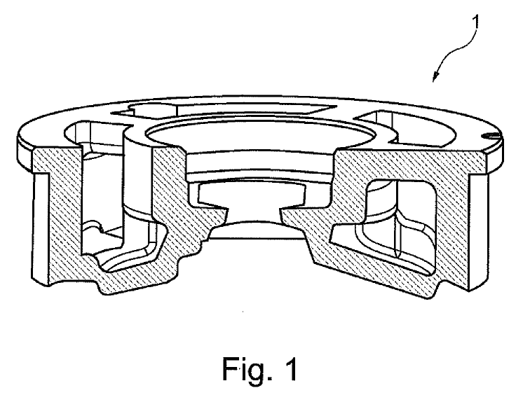

FIG. 1 shows an upper piston part 1, which has been manufactured by gravity die casting in a casting mold produced by DMLS.

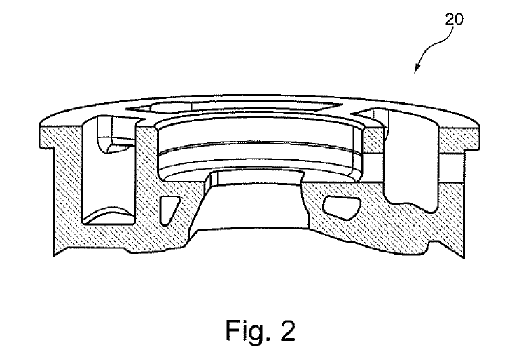

FIG. 2 shows a further upper piston part 20, which has been manufactured by gravity die casting in a casting mold produced by DMLS.

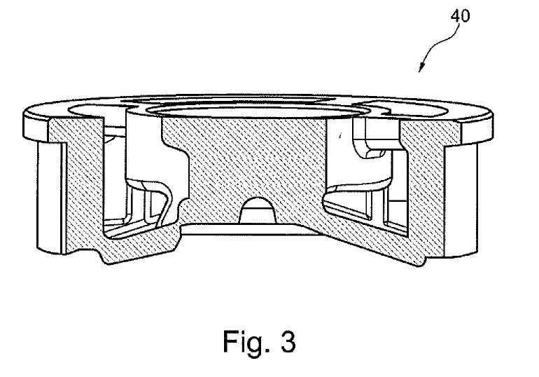

FIG. 3 shows a further upper piston part 40, which has been manufactured by gravity die casting in a casting mold produced by DMLS.

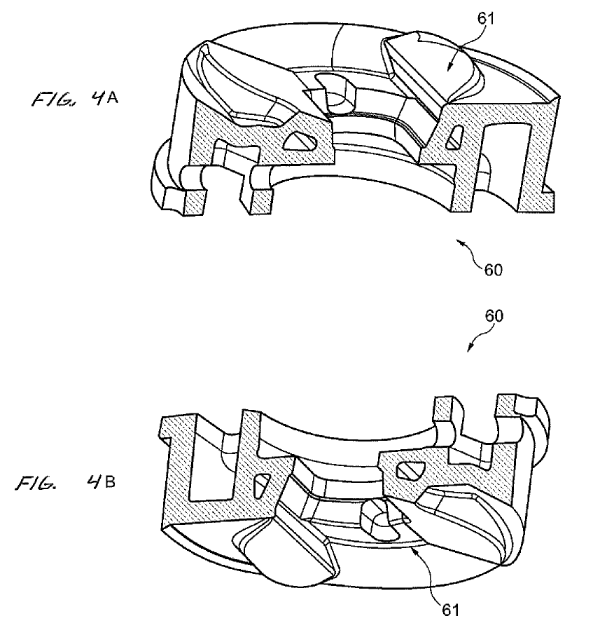

In FIGS. 4A and 4B, two views of a further refinement of an upper piston part 60 are shown. In the region 61, the contact region in relation to a sintering base (not represented here) of a casting mold (likewise not represented) can be seen. With the aid of DMLS, sintering bases for use in the casting mold for manufacturing pistons were produced. These sintering bases were used in the manufacture of the upper piston part 60 by gravity die casting. In the production of the sintering bases, microscopic holes were made by using DMLS with 0% porosity or a density of 7.8 g/cm3. 18,000 microscopic holes with a diameter D of 0.2 mm were used. This achieved an absorbency that was tripled in comparison with bases previously produced by electrical discharge machining and used. Furthermore, a lightweight structural concept with a uniform wall thickness was put into practice.

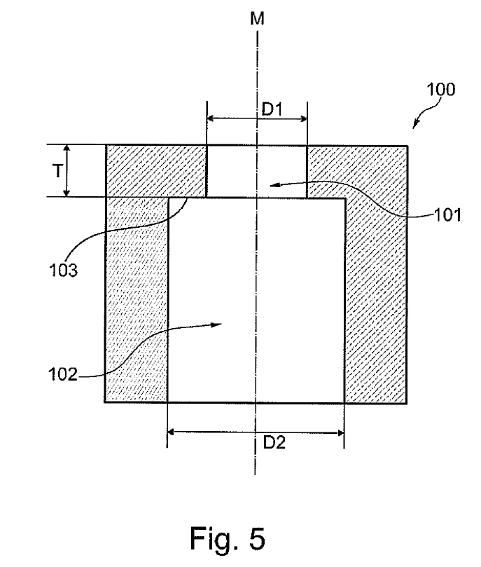

FIG. 5 shows a test piece 100 for the examination of microscopic holes 101, 102 produced by DMLS. The test piece 100 has the outer dimensions 10×10×10 mm (length×width×height), and consequently forms a cuboid. The middle of the test piece 100 is identified by M. The test piece 100 has a graduated test hole, in which one diameter D2 is kept fixed at 0.50 mm during the series of tests. The other diameter D1 is varied according to the following table between 0.1 and 0.23 mm. Furthermore, the depth T of the microscopic hole with the diameter D1 is varied in the series of tests between 1 and 5 mm. This produces a graduation 103 that is presented in the following table. The microscopic holes 101, 102 by using DMLS were made with 0% porosity. If this was not feasible, the exposure parameter was given as a variation of the porosity. In the water jet test, it was visually assessed how the water jet passes through or leaves the respectively created microscopic hole 101. It was assessed as “ok” if the water jet did not become atomized on passing through the respective microscopic hole 101, but emerged as a unified jet. The results of the water jet test can be taken from the following table. A diameter D1 of 0.20 mm with a depth T (graduation 103) of 5 mm has proven to be particularly positive. This pair of values is assigned in the table to specimen no. 15.

Table for the DMLS microscopic hole series of tests

| Specimen no. | Diameter D1 | Graduation | Water jet test |
|---|---|---|---|
| 1 | 0.1 | 1 | fairly OK, as mist |
| 2 | 0.1 | 2 | fairly OK, as mist |
| 3 | 0.1 | 3 | fairly OK, as mist |
| 4 | 0.1 | 4 | fairly OK, as mist |
| 5 | 0.1 | 5 | fairly OK, as mist |
| 6 | 0.15 | 1 | OK, water |
| 7 | 0.15 | 2 | OK, water |
| 8 | 0.15 | 3 | OK, water |
| 9 | 0.15 | 4 | OK, water |
| 10 | 0.15 | 5 | OK, water |
| 11 | 0.2 | 1 | OK, water |
| 12 | 0.2 | 2 | OK, water |
| 13 | 0.2 | 3 | OK, water |
| 14 | 0.2 | 4 | OK, water |
| 15 | 0.2 | 5 | OK, water |
| 16 | 0.1; 0.13; 0.16, | 5 | OK, water |
| | 0.20; 0.23 | | |

1. (canceled)

2. A method for producing a casting mold, in particular a die, for gravity die casting for the manufacture of pistons for internal combustion engines, the method comprising:
forming the casting mold by direct metal laser sintering (DMLS).

3. The method as claimed in claim 2, wherein the step of forming the casting mold by DMLS further comprises:
forming the casting mold layer by layer by a laser acting on metal powder.

4. The method as claimed in claim 2, the step of forming the casting mold by DMLS further comprises forming a sintering base having microscopic holes.

5. (canceled)

6. The method as claimed in claim 4, wherein the step of forming the microscopic holes is produced further comprises:
forming the microscopic holes with a diameter of less than 0.50 millimeters (mm).

7. The method as claimed in claim 6, wherein the step of forming the microscopic holes further comprises:
forming the microscopic holes of a depth of between 1 and 10 millimeters (mm).

8. The method as claimed in claim 2 further comprising the step of:
heat treating the casting mold to increase the strength and toughness properties of the casting mold.

9. The method as claimed in claim 2 wherein forming the casting mold by DMLS further comprises:
forming temperature-control channels adapted to the topography of a form of the casting mold.

10. The method as claimed in claim 9, further comprising:
providing a fine filter at an entry point of the temperature-control channels.

11. The method as claimed in claim 2 wherein the casting mold is made in a hybrid type of construction with a base.

12. The method as claimed in claim 11, wherein the base serves as a basis for the buildup of a piston-specific casting mold by DMLS.

13. The method as claimed in claim 11, further comprising:
introducing one of cooling, ejector or threaded holes into a base region before forming the casting mold by DMLS.

14. A casting mold for use in producing pistons for internal combustion engines by gravity die casting, the casting mold die formed by the process comprising:
direct metal laser sintering (DMLS) a casting mold for a piston for an internal combustion engine; and
forming microscopic through holes in a sintering base using DMLS to prevent air pockets in the piston.

15. The casting mold die of claim 14 wherein the forming of microscopic through holes further comprises:
forming the through holes with a diameter of less than 0.5 millimeters (mm).

16. The casting mold die of claim 15 wherein forming of the microscopic through holes further comprises:
forming the through holes over a depth between one (1) millimeter (mm) and ten (10) millimeters (mm).

17. The casting mold die of claim 14 further comprising:
heat treating the casting mold operable to increase the strength and toughness of the casting mold.

18. The casting mold die of claim 14 further comprising:
direct metal laser sintering (DMLS) a temperature control channel adapted to the topography form of the casting mold.

19. The casting mold die of claim 14 wherein casting mold is a hybrid construction.

20. The casting mold die of claim 14 further comprising:
introducing the cooling, ejector or threaded holes in a base portion before using the DMLS to form the casting mold.

21. The method as claimed in claim 6 wherein the step of forming the microscopic holes further comprises:
forming the microscopic holes with a diameter between 0.1 millimeters (mm) and 0.25 millimeters (mm).

22. The method as claimed in claim 7 wherein the step of forming the microscopic holes further comprises:
forming the microscopic holes of a depth between four (4) and six (6) millimeters (mm).

23. The method as claimed in claim 10 wherein the step of providing the fine filters further comprises:
forming the fine filters through DMLS.
